(19) United States
(12) Patent Application Publication
(10) Pub. No.: US 2004/0114747 A1
(43) Pub. Date: Jun. 17, 2004

(54) Systems and methods for call processing

(76) Inventors: David S. Trandal, Santa Barbara, CA (US); David J. Brahm, Santa Barbara, CA (US); Leo S. Jeghelian, Rockport, MA (US); Alan B. Erringer, Santa Barbara, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/462,082

(22) Filed: Jun. 13, 2003

Related U.S. Application Data
(60) Provisional application No. 60/433,541, filed on Dec. 12, 2002.

(51) Int. Cl. H04M 3/42

(52) U.S. Cl. 379/211.02; 379/207.16

(57) ABSTRACT

The present invention provides processes and apparatus for discouraging unwelcome calls. A call, including caller signaling information, is received from a caller. A determination is made that the caller is, or potentially is a telemarketer based on Caller ID information content. The caller is then provided with special call handling.

### PRIORITY CLAIM

This application claims the benefit under 35 U. S. C. 119(e) of U. S. Provisional Application No. 60/433,541, filed Dec. 12, 2002, the content of which is incorporated herein by reference in its entirety.

### BACKGROUND OF THE INVENTION

1. Field of the Invention

The present invention relates generally to telecommunications, and in particular to systems and methods for processing telephone calls.

2. Description of the Related Art

Telemarketing has become an increasing annoyance to phone service subscribers. Many people targeted by telemarketers do not desire to receive or answer telemarketing calls. A variety of conventional attempts to solve this problem exist, but many of these attempts are inadequate.

For example, one conventional method for reducing the quantity of telemarketing calls is for a subscriber to request that the subscriber's telephone number be removed from the telemarketer's call list. However, some telemarketers may not honor the request. Further, new call lists may be generated which would still include the subscriber's phone number.

Another conventional technique for reducing the quantity of telemarketing calls is the use of a Caller ID device to block or screen calls originating from specific phone numbers. However, many telemarketing services use telephone networks that are not capable of providing the information needed by the Caller ID device, or designate their phone number as private, and so the Caller ID device often cannot selectively block the telemarketer calls.

Still another technique uses a circuit connected directly to the user's telephone line that sends an imitation intercept Special Information Tone (SIT) sequence each time the owner's phone is taken off hook, with the intention of causing any predictive dialing telemarketing system to disconnect the call. Disadvantageously, using this technique requires a specialized SIT generating circuit in each subscriber's home, coupled to the subscriber's telephone line. Further, this technique requires that the called number not be busy when called by the telemarketer in order for the specialized SIT generating circuit to generate the imitation intercept tone, and as a further disadvantage, plays the imitation intercept tone to all received calls, regardless of the source.

### SUMMARY OF THE INVENTION

Embodiments of the present invention are directed to methods and systems for intercepting and/or blocking telephone calls. Embodiments of the present invention can be used to intercept, block, and/or discourage unwelcome telephone calls, such as those from telemarketers. Thus, embodiments of the present invention can reduce the number of telemarketer calls that are placed to subscribers, reduce the number of telemarketer calls that get through, and to notify telemarketers to add subscriber names to do-not-call lists.

In one embodiment, a call processing system, remote from the subscriber, receives a call for a subscriber over the Public Switched Network (PSTN). The call may be received as a direct call from a caller to a number associated with the call processing system but assigned to the subscriber by the call processing system operator, or the call may have been forwarded to the call processing system. Calls to a subscriber telephone number or line can be forwarded to the remote call processing system if, for example, the subscriber's line is busy, a ring-no-answer condition exits, or the subscriber's line is set to have all calls forwarded to the call processing system (sometimes called do-not-disturb).

Once the call is received by the call processing system, a determination or inference is made that the calling party is, or there is a significant possibility that the calling party may be, a telemarketer. The inference may be based on one or more criteria. For example, an inference or determination can be made that a caller is a telemarketer based on one or more of the following conditions:

Caller ID unavailable

Caller ID available but private

Caller ID available and matches known or previously suspected telemarketers based on a comparison of at least a portion of the Caller ID information with information stored in a centralized, publicly or generally available database, such as one maintained by a governmental authority that stores phone numbers and the like associated with telemarketers, or from a proprietary database maintained by the call processing system. For example, the call processing system may keep a record of the telephone numbers of callers that have been identified by subscribers as being from telemarketers.

In addition or alternatively, the call processing system may keep a record of the telephone numbers of callers that have been automatically identified by the call processing system as being from suspected telemarketers based on one more criteria, such as receipt of more than a predetermined number of calls, either directly or via a forwarding operation, from the caller within a predetermined amount of time.

Upon making the determination or inference that the caller is a telemarketer or potentially is a telemarketer, the call processing system provides specialized call treatment for the call. For example, the call processing system can generate a not-in-service or other rejection indicator to the calling party, even though the subscriber's telephone line or number is in service. The specialized call treatment can include, by way of example, generating selected Special Information Tone (SIT) signals, generating selected SS7 reject signals, answering the call and requesting and recording the caller's name in computer readable memory so that the subscriber can screen the call, or answering the call and playing an audio message indicating the calls from telemarketers or other solicitors are not welcome and disconnecting the call.

By way of further example, the specialized call treatment can include answering the call and playing an audio message indicating the calls from telemarketers or other solicitors are not welcome, but still take a message or forward the call to the subscriber after one or more of the following: a predetermined amount of time if the caller has not dropped the call; requesting that the caller provide a DTMF signal by pushing a button on the telephone or the like and then receiving the DTMF signal; or requesting that the caller enter a code associated with the called subscriber using DTMF tones.

The not-in-service or other rejection indicator may be, by way of example, an answering tone incorporating the first tone of the three-tone Special Information Tone (SIT) sequence, which indicates to predictive dialers that the dialed number is non-working or not in service. This SIT tone is sometimes referred to as an intercept (INT) SIT or SIT2 tone, and will be referred to herein as a “blocking tone.”

In addition or alternatively, SS7 signaling call rejection indicators, specifying that the call cannot be completed, can be used as well. The call reject indicator may be simulated, in that the condition indicated may not exist, however the telemarketer will be “fooled” into believing the condition causing the rejection does exit. The SS7 signaling call reject indicators and blocking tones are also referred to herein as blocking signals.

Thus, embodiments of the present invention can generate a not in service indicator, without having to answer the subscriber's phone, and when the subscriber's line is busy, not answered, and/or has all calls forwarded to the call processing system.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1 illustrates an example telecommunications system that can be used in accordance with one embodiment of the present invention.

FIG. 2 further details the subsystems that comprise the call processing system depicted in FIG. 1 described above.

FIG. 3 illustrates an example call flow diagram.

FIG. 4 illustrates a first example call handling.

FIG. 5 illustrates a second example call handling.

FIG. 6 illustrates a third example call handling process.

FIG. 7 illustrates a fourth example call handling process.

FIGS. 8A-C illustrate example user interfaces.

### DETAILED DESCRIPTION OF PREFERRED EMBODIMENTS

Embodiments of the present invention are directed methods and systems for intercepting and/or blocking telephone calls. As will be described in greater detail below, embodiments of the present invention can be used to intercept, block, and/or discourage unwelcome telephone calls, such as those from telemarketers. Embodiments of the present invention can even block calls while the user's phone line is busy, such as when the user is using the line to access the Internet via a computer terminal. Thus, embodiments of the present invention can reduce the number of telemarketer or other unwelcome calls that are placed to subscribers, reduce the number of telemarketer calls that get through, and to request telemarketers to stop placing calls to subscribers.

In one embodiment, a user, also referred to as a subscriber, can selectively enable the telemarketing call processing features. Calls to a subscriber telephone number or line are forwarded to a remote call processing system using the subscriber's local phone company's fixed and variable call forward functions. These functions can include, by way of example, call forwarding on busy, call forwarding on ring-no-answer, and call-forward-all calls (sometimes called do-not-disturb). In one embodiment, a determination or inference is made that the calling party is, or there is a significant possibility that the calling party may be a telemarketer. Upon making such determination or inference, the call processing system generates a not-in-service or other rejection signal or indicator to the calling party, even though the subscriber's telephone line or number is in service.

The not-in-service indicator or other rejection signal may be, by way of example, an answering tone incorporating the first tone of the three-tone Special Information Tone (SIT), which indicates to predictive dialers that the dialed number is non-working or not in service. This SIT is sometimes referred to as an intercept SIT or SIT 2 tone. Optionally, two or all three SIT tones can be played. The one or more SIT tones can be played before answering the call, after answering the call, or both before and after answering the call.

Other SIT tones may be used as well. For example, No Circuit (NC), ReOrder (RO), Vacant Code (VC), Intercept (INT), and/or Ineffective Other (IO) tones can also be used.

SIT Coding assignments, in Freq(Hz)/Duration(ms), are as follows:

| | Tone 1 | Tone 2 | Tone 3 |
|---|---|---|---|
| NC | 985.2/380 | 1428.5/380 | 1776.7/380 |
| INT | 913.8/274 | 1370.6/274 | 1776.7/380 |
| VC | 985.1/380 | 1370.6/274 | 1776.7/380 |
| RO | 913.8/274 | 1428.5/380 | 1776.7/380 |
| NC | 913.8/380 | 1370.6/380 | 1776.7/380 |
| RO | 985.2/274 | 1370.6/380 | 1776.7/380 |
| IO | 913.8/380 | 1428.5/274 | 1776.7/380 |

One or more of the SIT tones are optionally incorporated into a specialized or branding tone associated for identification purposes with the call processing system service provider. The playing of the SIT tones may be selectively played at least partly in response to determining or inferring that the calling party is or there is a significant possibility that the calling party may be a telemarketer. Advantageously, the branding tone can be selected to be pleasant to listeners, and therefore to make the SIT or other blocking tone less noticeable by legitimate callers.

In addition or alternatively, SS7 signaling call reject indicators, instructions, or other blocking signals can be used as well. For example, SS7 class 10 cause codes, including code 34 (no circuit/channel available), code 38 (network out of order), code 41 (temporary failure), code 42 (switch congestion), code 44 (requested circuit/channel unavailable), code 47 (resources unavailable, unspecified), can be used. Other SS7 cause codes can be used, such as, by way of example, class 000 and 001 cause codes, including code 1 (unassigned number), code 0 (invalid code, but used by some systems), code 2 (no route to transit network), code 3 (no route to destination), code 4 (send special information tone), code 5 (misdialed prefix), code 16 (normal call clearing), code 17 (user busy), code 18 (no user response), code 19 (no answer, user alerted), code 21 (call rejected), code 22 (number changed), code 27 (destination out of order), code 28 (address incomplete), code 29 (facility rejected), and code 31 (normal unspecified). Other codes can be used as well.

Thus, embodiments of the present invention can generate a not in service or other call rejection indicator, without having to take the subscriber's phone off-hook, and when the subscriber's line is busy, not answered, and/or has all calls forwarded to the call processing system.

Advantageously, if the telemarketer is using a predictive or auto-dialer system to place the phone call, upon receiving the out-of-service and/or other rejection indicators the predictive or auto-dialer system can automatically delete the subscriber phone number from its database. The subscriber will then not receive further annoying calls from the telemarketer.

Predictive dialing systems often automatically dial the telephone using phone numbers stored in a database, and connect a human telemarketer when live voice contact is made. Predictive dialing systems accomplish this by ‘listening’ and filtering out call rejection indicators, answering machines, busy signals, operator intercepts, and other types of non-functional calls. Further, some predictive dialing systems delete not-in-service numbers and/or numbers associated with other rejection indicators, from their database.

The determination or inference that the calling party is potentially a telemarketer is accomplished using one or more techniques. A common practice of telemarketers is to originate calls in a way in which the calling party ID field is not populated, or if the calling party ID field is populated, to designate it as private. The call processing system determines if a call has the caller ID populated or optionally if the caller ID is available but private. Optionally, the call rejection indicator or other blocking signal is selectively generated for only a certain percentage of calls to a given subscriber number having an unavailable caller ID, and/or caller ID private. For example, the call rejection indicator or other blocking signal can be played to every n^{th} (where n is an integer value) call to a given subscriber number having an unavailable caller ID, and/or caller ID private. The percentage or value of n can be predetermined or can be dynamically varied based on the number of complaints received from the given subscriber or from the subscriber base in a given period of time. Advantageously, by blocking a fraction of calls having an unavailable caller ID, and/or caller ID private will allow callers whose service does not provide caller ID information to still be able to leave a message or read the subscriber.

In addition, an inference or determination can be made that the call is from a telemarketer when the Caller ID is available and matches known or previously suspected telemarketers based on a comparison of at least a portion of the Caller ID information with information accessed from a telemarketer phone number database.

By way of example, a centralized, publicly available telemarketer database can be maintained or authorized by a governmental authority. The telemarketer database stores telemarketer phone numbers, identification information, and the like. Telemarketers can be required by federal or state law, statute, regulation, or the like to register their phone number(s) and identification information in such a database. In addition, or alternatively, other telemarketer databases can be accessed by the call processing system as well. For example, a proprietary or non-governmental database can be maintained by the call processing system.

In addition, a subscriber can optionally have a telemarketer database associated specifically with, or personal to the subscriber. The subscriber-specific telemarketer database can include a list of phone numbers associated with calls that the subscriber had previously identified as being from a telemarketer using the Client application, via a web base form, or using other data entry techniques.

For example, the call processing system can record in a telemarketer telephone number database the telephone numbers of callers that have been identified by subscribers as being from telemarketers. The subscribers can use a client application as discussed below, a web form, or other data entry tool to provide the call processing system with a caller's phone number so as to identify the caller as a telemarketer. If the subscriber is receiving a call via a computer terminal using VoIP, a Telemarketer ID software button or the like on the client application can be activated by the subscriber and the client application sends the Caller ID information with information identifying the call as being from a telemarketer to the call processing system, which then automatically stores the information in the telemarketing phone number database.

A filter can be used to better ensure that phone numbers are not mistakenly identified as telemarketer phone numbers. For example, a threshold can be set where a certain number of subscribers need to identify a telephone number as being that of a telemarketer before the call processing system provides the specialized call processing for telemarketers to calls originating from that telephone number. Thus, for example, if only one person, as a joke or by mistake, identifies a phone number as a telemarketer's phone number, future calls from that number will not be treated as a telemarketing call. The threshold can be set, by way of example, at 5, 10, 100, 1000, 10, 000, or at other values.

In addition or alternatively, the call processing system can record in the database telephone numbers of callers that have been automatically identified by the call processing system as being from suspected telemarketers based on one more other criteria, such as receipt of more than a predetermined number of calls, either directly or via a forwarding operation, from the caller to one or more subscribers within a predetermined amount of time. The number of calls can be tracked by the call processing system with respect to the calls forwarded from the subscribers line to the call processing system or that are placed directly to a phone number answered by the processing system that is associated with a subscriber. Thus, for example, if the call manager system counts more than 1000 calls from a given number to more than 250 subscribers within one week, the originating phone number is identified as being associated with a telemarketer and accordingly stored in the telemarketing phone number database.

The number of calls and the number of subscribers to whom the calls are placed can be treated separately or together in identifying a telemarketer phone number. For example, if 1000 calls are received from the same number in 24 hours by ten or more subscribers, the number is identified as a potential telemarketer phone number. If 50 calls are received from the same number in 24 hours by 25 or more different subscribers, the number is identified as a potential telemarketer phone number. However, if 50 calls are received from the same number in 24 hours by only one subscriber, the number is not identified as a potential telemarketer phone number. Of course different time periods and different values for the number of calls and the number of subscribers can be used in other examples.

One example expression for identifying a phone number as being associated with a potential telemarketer is as follows:

If for a calling number the (Number of Calls)*(Number of Called Parties)/(Time Period+Constant)>Threshold then identify calling number as being associated with a potential telemarketer.

where:

Number of Calls=the total number of calls originated from a given calling number to call processing system service subscribers within the Time Period that are processed by the call processing system;

Number of Called Parties=the number of different subscribers to whom the calls in the Number of Calls were placed to;

Time Period=the time period over which the Number of Calls are calculated The time period can be in units of milliseconds, seconds, hours, days, weeks, months, years, or in other units of measurement.

Thus, the more calls there are from a calling number to more subscribers over a shorter amount of time, the more likely that the threshold will be exceeded and the calling number will be identified as being associated with a potential telemarketer. The constant is used to ensure that an adequate time period elapses before the threshold is exceeded. For example, if the Time Period is in units of days, Constant can be set equal to 1. Of course other formulas, criteria, and constants can be used as well.

Upon making the determination or inference that the caller is a telemarketer or potentially is a telemarketer, the call processing system provides specialized telemarketer call treatment. For example, the call processing system can generate a not-in-service or other rejection indicator to the calling party, even though the subscriber's telephone line or number is in service. The specialized call treatment can include, by way of example, generating selected Special Information Tone (SIT) signals, generating selected SS7 reject signals, answering the call and requesting and recording the caller's name so that the subscriber can screen the call, or answering the call and playing an audio message indicating that calls from telemarketers or other solicitors are not welcome, and then disconnecting the call.

By way of further example, specialized call treatment can include answering the call and playing an audio message indicating that calls from telemarketers or other solicitors are not welcome, but still take a message, or recording the caller's name so that the subscriber can screen the call, after one or more of the following:

a predetermined amount of time if the caller has not dropped the call;

requesting that the caller provide a DTMF signal by pushing a button on the telephone or the like and then receiving the DTMF signal;

requesting that the caller enter a code associated with the called subscriber using DTMF tones. The subscriber can provide selected welcome telemarketers with the code so that they can get through to the subscriber's voice mail or line. This is useful when there is a telemarketer that offers services or products that are attractive to the subscriber, or where the subscriber has already agreed to purchase a product or service from the telemarketer, and the telemarketer will need to place follow-up calls to the subscriber regarding the order.

In addition, a subscriber can instruct the call management system to selectively treat calls from one or more telemarketers as normal calls, while having calls from other telemarketers treated using the specialized telemarketer call treatment. The subscriber provides the welcome telemarketer's phone number and instruction via the client application or otherwise. As similarly discussed above this process is useful when there is a telemarketer that offers service or products that are attractive to the subscriber, or where the subscriber has already agreed to purchase a product or service from the telemarketer, and the telemarketer will need to place follow-up calls to the subscriber regarding the order. The instruction and a phone number are stored in a database in association with the subscriber's account information. Then, when calls are received from the welcome telemarketer, a comparison of the telemarketer's Caller ID information with the telemarketer's phone number stored in association with subscriber's account information will be performed, and when a match occurs, the call will be treated normally. The subscriber can be allowed to add or delete telemarketer telephone numbers from the “welcome” category.

If the call does not have the caller ID field populated, or if multiple calls are received over fixed intervals with unavailable caller ID, and/or if the caller ID is available but private, the not-in-service or other call rejection indicator is provided as described above, and a prompt is optionally provided asking the caller for their name. Optionally, the prompt can announce to the caller that the subscriber does not accept unidentified calls. This will cause many telemarketers to drop the call. Advantageously, in one embodiment, the subscriber does not have to be aware or intervene when a telemarketer's call is being processed. Furthermore, when the call has been forwarded to the call processing system as discussed above, the caller does not incur a network toll-charge expense if the blocking signal is provided before the call is answered or accepted from an SS7 perspective, and the caller then drops the call, since the call has not been answered or accepted.

Optionally, the subscriber can be informed how many telemarketer calls were blocked over a given period of time. The term “blocked call,” as used herein, refers to a call where an inference is made that the call was dropped by the caller in response to the out of service and/or other call rejection indicator. For example, a dropped call can be designated as a blocked call if the call is dropped within a configurable amount of time after the out of service and/or other call rejection indicator. By way of further example, the dropped call can be designated as a blocked call if two or more criteria are met, such as if the call is dropped within a configurable amount of time after the call rejection indicator is provided and if no message is left. Other criteria can be used as well.

In one embodiment, the subscriber computer client presents a client call log. The client call log can include a blocked call entry indicating which calls were blocked because they were inferred to possibly be telemarketing calls, and showing the date and time of the blocked calls. When a subscriber double-clicks or clicks “play” on a “Telemarketer Blocked” entry in the call log, a tool-tip balloon or the like is optionally displayed with call information, such as identifying the time of the blocked call. The client can optionally also be used by the subscriber to enable or disable telemarketer call blocking via a command provided via menu, tab, link, button, other controls or the like. The subscriber's configuration settings, including the enabling or disabling of telemarketer call blocking, are stored by the call processing system in a subscriber database or the like.

In another embodiment, the call processing system answers the forwarded calls and plays a greeting to the caller. At the same time, a communication channel is opened with the subscriber over the public Internet and speech is “streamed” to the subscriber and played over the speakers of the subscriber's computer, which may be, by way of example, a personal computer or networked television.

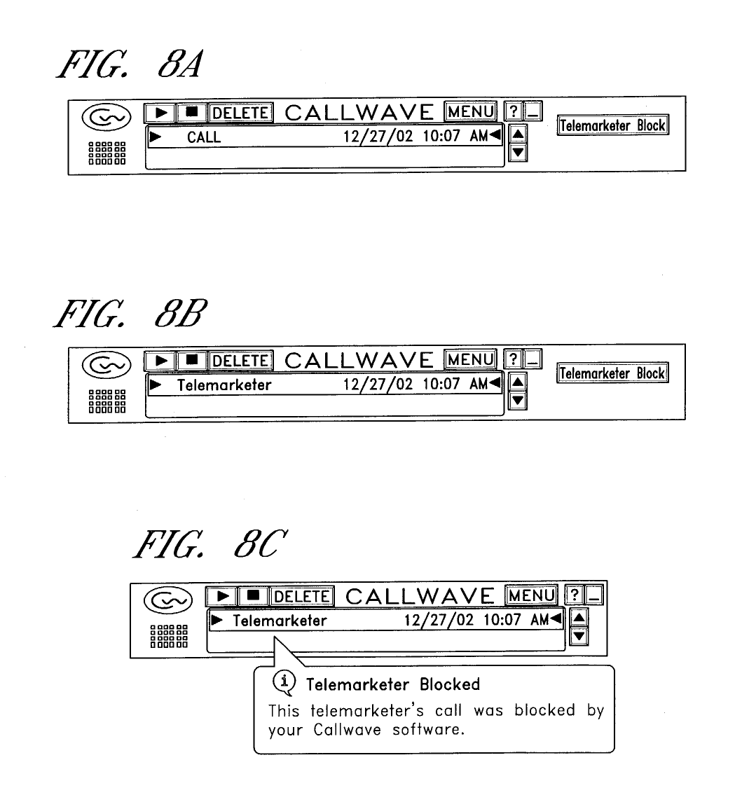

Optionally, the subscriber's client application can provide the subscriber with an interface for rejecting or to otherwise handle the telemarketer's call. Thus, for example, as the telemarketer is leaving a message the subscriber can select a “Block Telemarketer” option presented as a button, menu selection, link, or the like. FIGS. 8A-C illustrate example user interfaces that can be displayed on the subscriber's computer terminal screen. The interface can float over existing windows or can be in its own window.

FIG. 8A illustrates the user interface for the case where a call comes in, but it has not been identified by the call processing system as a telemarketer call. The user interface displays the time and date of the call. The subscriber can activate the Telemarketer Block control, and an instruction is sent over the Internet to the call processing system. If the call has available Caller ID information, then the call processing system records that the user has identified the caller as a telemarketer. This information can be used to build the telemarketer phone number database discussed above. In addition, the call processing system will perform specialized call treatment, such as providing the call with a blocking signal.

FIG. 8B illustrates the user interface for the case where a call comes in, and the call processing system has identified the caller as being a telemarketer or a potential telemarketer. The subscriber can activate the Telemarketer Block control, and as discussed with respect to FIG. 8A, an instruction is sent over the Internet to the call processing system. At least partly in response, the call processing system will perform specialized call treatment, such as providing the call with a blocking signal.

FIG. 8C illustrates the user interface for the case where a call has been successfully blocked. The user interface displays the time and date the call was successfully blocked.

Optionally, if Caller ID information is available, the call processing system keeps track of how many subscribers have activated the “Block Telemarketer” option for calls having the same Caller ID information, and as discussed above, can treat future calls from that number using specialized telemarketer call treatment. If the subscriber does reject the telemarketer call, a rejection message is played back to the caller. For example, the rejection message may state “The person you are calling does not accept phone solicitations. Please add this person's name and telephone number to your DO NOT CALL list.”

If the subscriber wishes, the subscriber can instruct the call processing system to connect the subscriber to the telemarketer. The call processing system interrupts the telemarketer, who may be in the process of leaving a message, by playing a voice prompt, such as “please hold while we connect your call.” If the subscriber computer is sharing the phone line with the subscriber's phone, the call management system optionally causes the subscriber computer to be disconnected from the Internet, originates a new call from the call processing system to the subscriber's POTS (plain old telephone service—which refers to the standard telephone service that most homes use) phone, and bridges the two calls together.

Throughout the following detailed description, the term “Web site” is used to refer to a user-accessible network site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically distributed computer systems that are appropriately linked together. Furthermore, while the following description relates to an embodiment utilizing the Internet and related protocols, other networks, such as networked interactive televisions, and other protocols may be used as well.

In addition, unless otherwise indicated, the functions described herein are preferably performed by executable code and instructions running on one or more general-purpose computers. However, the present invention can also be implemented using special purpose computers, state machines, and/or hardwired electronic circuits. In addition, a communications line is referred to as “busy” when the communication line is being utilized in such a way that a conventional incoming call will not be connected to the communications line. Thus, for example, if a user is utilizing a conventional line capable of only conducting one of a conventional voice session and a data session, but not both at the same time, for a data session, the line will be busy.

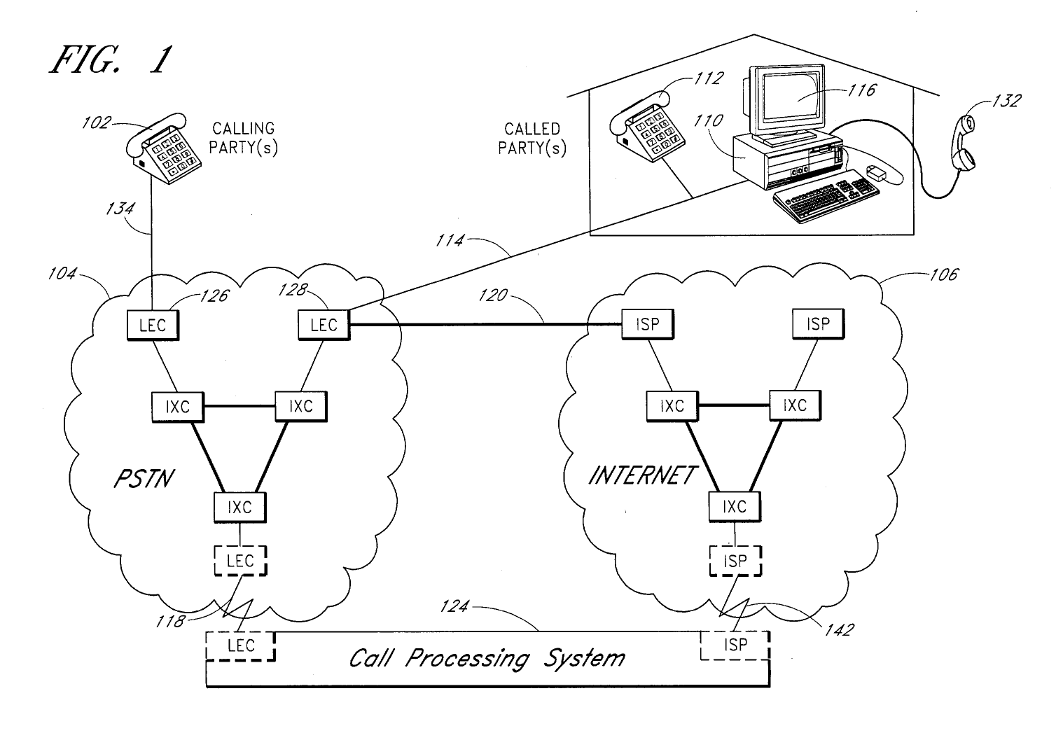

FIG. 1 illustrates an example telecommunications system that can be used in accordance with the present invention. As illustrated, the telecommunications system includes:

a calling party user telephone system 102, which can be a predictive or autodialer associated with a telemarketer.

a subscriber telephone station 112.

an optional subscriber computer terminal 110.

a call processing system 124 that provides call answering service and telemarketing blocking services as described herein.

In this example, these devices are linked together using various line and trunk circuits to a Public Switched Network (PSTN) 104 and to a common data network, such as the Internet 106.

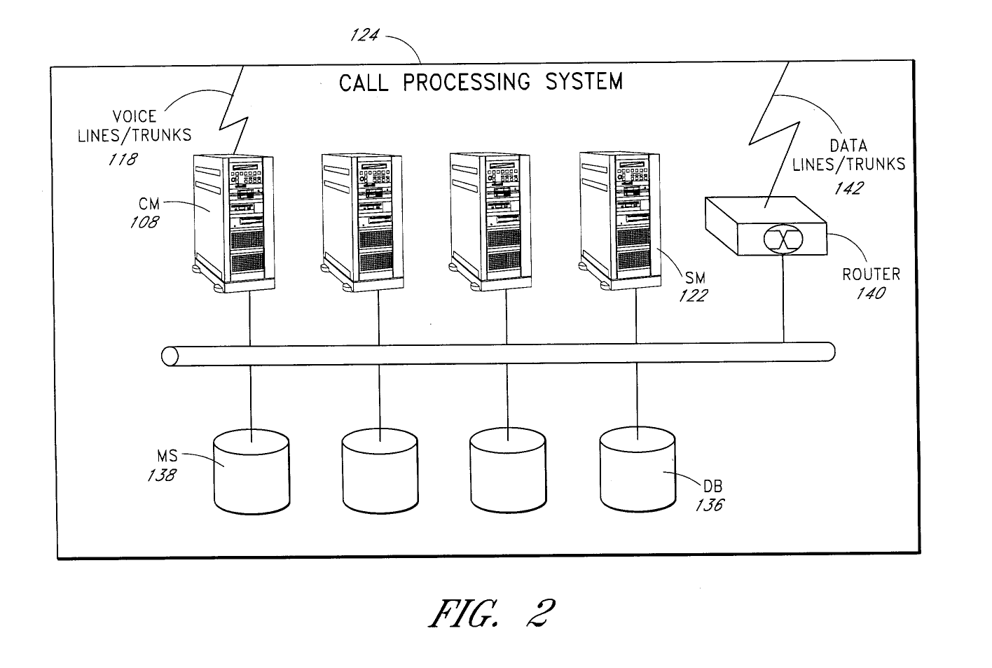

FIG. 2 further decomposes the example call processing system 124 into its functional components:

a Call Management (CM) subsystem 108, which serves as the interface to the PSTN 104 to manage inbound and outbound telephone calls.

a Router subsystem 140, which serves as the interface to the Internet 106 to manage communications between online IP client devices and the various call processing servers.

an optional online presence detection Internet Session Management (SM) subsystem 122, which monitors the status of subscriber data terminals to determine its availability for call handling services.

a shared Media Storage (MS) subsystem 138, which persistently archives callers' voice messages and the called party/subscriber's personal greeting(s),

a call processing Database (DB) subsystem 122 in which called party/subscriber call processing service parameters are stored. In addition, the call processing Database (DB) subsystem 122 optionally includes a telemarketer telephone number database that stores the telephone numbers of known or suspected telemarketers.

Theses various subsystems are interconnected using, by way of example, a Local Area Network (LAN) and/or a Wide Area Network (WAN).

The call processing system 124 works with the “Call Forward On Busy” feature of a standard phone line to answer calls while the subscriber is online and is using the phone line to access the Internet. Once activated, callers do not get annoying busy signals when the subscriber is online. Instead, callers hear a brief greeting after which they can leave a short message. Similarly, the call may be received as a direct call to a number associated with the call processing system but assigned to the subscriber by the call processing system operator, or the call may have been forwarded to the call processing system on a ring-no- answer condition exits, or if the subscriber's line is set to have all calls forwarded to the call processing system (sometimes called do-not-disturb). The recording, stored in computer readable memory, such as RAM or non-volatile memory can be streamed in substantially real-time or sent to the subscriber over the Internet within seconds after the recording has completed. The subscriber can elect to interact with the caller while they are still on the line or can call them back at a later time.

The telephone stations 102, 112 can be coupled to the same switch or different switches. Referring back to FIG. 1, in this example the telephone stations 102, 112 are respectively connected to local exchange switches (LEC) 126, 128 via telephone lines 134, 114. The station 102 can optionally be a predictive or autodialer telephone system, while the subscriber telephone station 112 can optionally be conventional POTS (Plain Old Telephone Service) telephones or a local extension behind a corporate Private Branch Exchange (PBX).

If the telephone stations 102, 112 are coupled to the same switch, the switch will be local to both the calling and called parties, such as for intra-LATA or local calls. If telephone stations 102, 112 are coupled to different switches, each switch may be local only to one of the parties, as is the case for non-local calls such as inter-LATA (long- distance) calls.

In the illustrated embodiment, the CM subsystem 108 is coupled into the PSTN 104 through voice trunk circuits 118 directly interfacing with the Inter Exchange Carrier's (IXC) circuit switched or packet switched telephony network. Thus, advantageously the call processing system 124 does not have to be directly serviced by the same Local Exchange Carrier's (LEC) switch or PBX as the calling or called terminals 102 and 112. Indeed, the call processing system 124 or its individual subsystem components can be located in a different country than the called and calling parties. In this instance, the call processing system 124 is optionally configured as, or to appear as, a telephone end office and can interface with the PSTN 104 as an end office or Class 5 switch. In other embodiments, the call processing system 124 is locally attached to a LEC switch with a physical line or local trunk interface circuit. This switch may or may not be serving telephone stations 102 and/or 112.

The call processing voice trunk circuits 118 are not limited to a particular signaling convention. For example, the present invention can be utilized with a Common Channel Signaling system, such as Signaling System 7 (SS7), having separate voice/user data and signaling channels. In addition, the present invention can be used with other signaling methods, such as the following trunk-side signaling interfaces: ISDN-PRI; Advanced Intelligent Network; and/or Service Node architectures. The signaling system can provide some or all of call presentation information discussed below to the call processing system 124:

ANI—Automatic Number Identification: phone number and privacy indicator of the calling party (“Caller-ID”), if available.

DNIS—Dialed Number Identification: phone number of the call processing system's voice trunks 118 that the call was forwarded to.

OCN—Original Called Number Identification: phone number of the original called party (subscriber to the call processing service), if available.

Charge Number. Indicates the chargeable number for the call.

Forwarding/Redirecting Number—phone number of the forwarding or redirecting party if the call was forwarded or redirected.

Call Type—Forwarded call due to a BCF, RNA, or DND/CFA condition. In addition, directly dialed inbound calls can be handled as well. In this instance, the caller will be requested to enter the subscriber's phone number or the subscriber could be assigned a unique personal number that is directly dialed by their callers.

The telephone lines 134, 114 can optionally be shared with one or more computer terminals. For example, telephone terminal 112 shares the telephone line 114 with a computer terminal 110. While in the illustrated example the computer terminal 110 is a personal computer, the computer terminal 110 can be an interactive television, a networked-enabled personal digital assistant (PDA), other IP (Internet Protocol) device, or the like. Alternatively, the computer terminal 110 can be a personal computer having a monitor, keyboard, a mouse, a disk drive, sound card or similar sound reproduction circuitry such as a codec, streaming media playback software, such as the Media Player program available from Microsoft, speakers, and a modem, such as a standard V.90 56K dial-up modem. The modem can optionally be configured to dial-up a number under control of an application, such as a contact manager application or telecommunications client application phone dialer, stored and executing on the computer terminal 110.

The telephone line 114, can be used to establish a dial-up connection for computer terminals, such as terminal 110 via the computer modem, to an Internet Service Provider (ISP) offering dial-in remote access service connections from the PSTN 104 via trunk interface circuits 120. The computer terminal 110 can also be connected to the Internet 106 via a broadband connection, such as a DSL line, a television cable line, or a T1 line.

In addition, the computer terminal 110 can be equipped with a Voice over Internet Protocol (VoIP) software module and a headset or a handset 132, including a microphone and speaker, allowing voice communications to be conducted over a computer network, such as the Internet 106. VoIP communicates information via packet switching, which opens a connection just long enough to send a small packet of data. Each packet includes a destination address informing the network where to send the packet along with the actual voice data payload. If the receiving station is also a VoIP terminal, then when the receiving terminal receives the packets, VoIP software executing on the receiving terminal reassembles the packets into the original data stream. The data stream is then converted to a voice signal. If the receiving station is a conventional telephone, then a VoIP gateway converts the packets into a voice signal that is then connected to the PSTN 104.

In one embodiment, the VoIP process is performed using the H.323 standardized protocol established by the International Telecommunications Union (ITU). Advantageously, H.323 provides specifications for real-time, interactive videoconferencing, data sharing and audio applications such as IP telephony. Alternatively, the Session Initiation Protocol (SIP), established by the Internet Engineering Task Force (IETF), can be used. SIP is generally more efficient than the H.323 protocol as SIP is specifically intended for IP telephony. Alternatively, proprietary protocols could be deployed where multi-vendor interoperability is not required.

Optionally residing and executing on the computer terminal 110 is a communications management Client application 116. The Client application 116 is used to provide enhanced communication services, such as services related to telemarketing call processing as describer herein. The Client application 116 is connected to and communicates with the call processing system 124 via the Internet 106, other private or public wide area computer networks, and the like.

The call processing system 124 optionally hosts a Web site used by subscribers of the call processing service to setup and manage their accounts, to view information about incoming calls, and to instruct the call processing system 124 on how to route incoming calls to one or more destination stations. Many of these same functions can be implemented by the Client application 116 as well.

The CM subsystem 108 manages communications with the Client application 116, if one is used, and with forwarded and direct calls, such as those from telemarketers. The CM subsystem 108 can interact with callers and called parties through voice prompts, voice commands, and/or DTMF touch-tone entries. The CM subsystem 108 is optionally configured to perform additional functions, such as acting as a telephone answering system that answers calls, playing outgoing greetings and announcements, recording incoming messages, and bridging calls. In addition, the CM subsystem 108 further provides the telemarketing blocking process as previously described.

The optional SM subsystem 122 monitors the Internet for online IP devices registered to call processing subscribers to determine their availability for call handling services, such as receiving the call log discussed above. When a user or subscriber connects to the Internet using, for example, a dial-up ISP, the Client application 116 executing on the subscriber's computer terminal 110 makes the subscriber's online presence known to the call processing system 124. Presence detection can be performed by the SM subsystem 122 polling or pinging the computer terminal 110 via the telecommunications Client application 116, or by the telecommunications Client application 116 transmitting a “Login/I'm alive” message and subsequent periodic “keep alive” messages to the SM subsystem 122. Just prior to the normal termination of the online Internet session, the Client application 116 sends a “Logout” message to the SM subsystem 122. Abnormal Internet session termination conditions are detected by the SM subsystem 122 timing out the expected Client “Keep alive” message.

If, rather than using a dial-up connection, the user or subscriber is using a broadband, always on-connection, such as via a DSL line or cable modem, the Client application 116 becomes active when computer 110 is powered up and/or the subscriber activates the application 116, and stays on until the user manually shuts down the Client application 116, or the computer 110 is turned off or powered down.

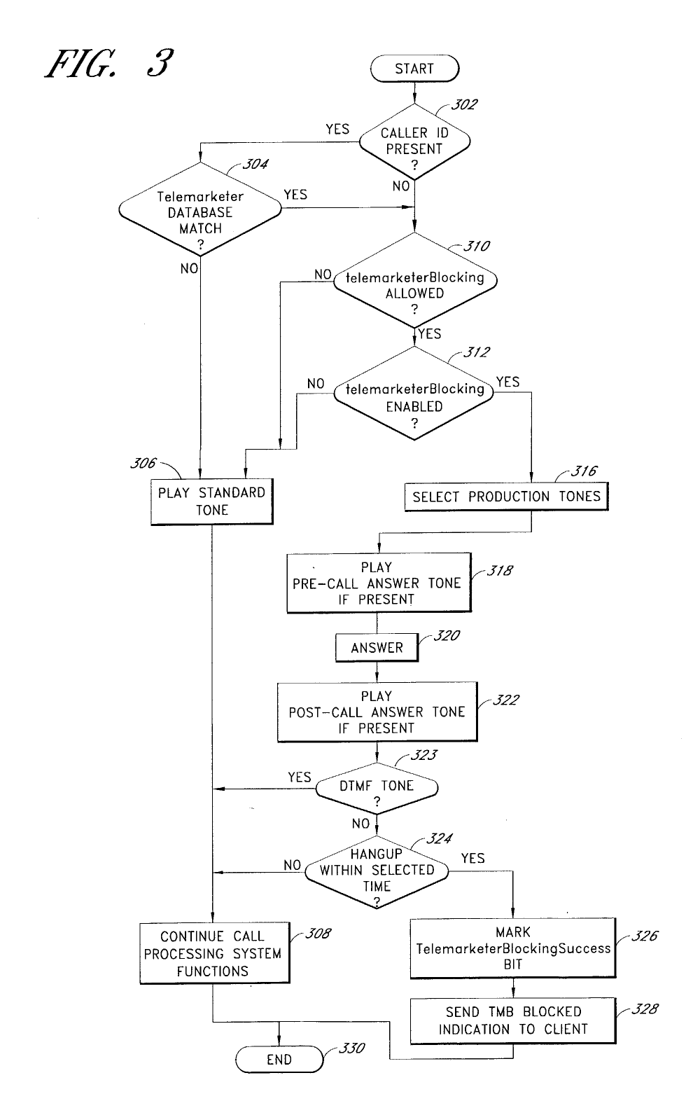

FIG. 3 illustrates an example call flow diagram for calls forwarded from the subscriber to a call management system, such as the call manager system 124. Not all the process states are required, nor do the process steps have to be performed in the order illustrated. Beginning at state 302, a determination is made as to whether the direct or forwarded call has an associated Caller ID present. If the Caller ID is present, the process proceeds to state 304, where the Caller ID information is compared against the telemarketing telephone number database. If there is no match the process proceeds to state 306, and a branding tone, or no tone at all, is played, and no call reject indicators are provided. If there is a match, the process proceeds from state 304 to state 310.

The process proceeds from state 306 to state 308 where the other call processing system functions can be performed. For example, for calls that come in with caller ID “available and not private,” substantially immediate notification of the call can be provided to the subscriber via the subscriber's computer client, the notification including call information, such as the caller's number, and call handling options. The call handling options can be presented via a dialog box and can include, for example,

1. Do nothing (Ignore Call).

2. Pickup the call to talk to the caller using a software (VoIP) telephone running on a subscriber computer terminal, such as terminal 110, which may be a home PC (Take The Call or TTC).

3. Pickup the call to talk to the caller using the “home phone” on the phone line used to connect to the Internet (the user telephone station 112).

4. Pickup the call to talk to the caller after transferring the call to an alternate phone or to an alternate PC.

5. Continue screening the call after transferring it to an alternate phone or to an alternate PC.

6. Terminate the call substantially immediately—optionally with a do not disturb message (Reject Call).

7. Do not answer the call.

Thus, under option (1) the subscriber may choose to ignore the incoming call. For example, the call may not have been urgent enough to interrupt what they are doing or the call may have been intended for another member of the household. Under option (1), the subscriber can close the call handling options dialog box, thereby informing the call processing system 124 that no further instructions for caller interaction will be forthcoming. Alternatively, the subscriber, having screened the Caller-ID of the incoming call and/or the associated caller's message, can simply continue doing what they were doing before the call arrived. After the caller has left a complete message, as indicated by the caller terminating the call or after a predetermined recording time period, the call processing system 124 downloads the recorded message to the subscriber's computer terminal 110 and updates the Client application's call log, which lists the calls handled by the call processing system 124 for the subscriber. The message is archived in the MS subsystem 138 and is also available locally on the computer terminal 110 for playback at the subscriber's convenience.

Under option (2), the subscriber may decide to pickup the call in progress to talk to the calling party using the computer terminal 110. Having screened the call, the subscriber can signal the call processing system 124 to indicate a desire to talk to the calling party using VoIP. After the subscriber has selected option (2), the Client application 116 sends an instruction by way of an Internet-based client/server control message to the call processing system 124. Upon receiving the instruction, the call processing system 124 interrupts the recording and streaming process and plays a canned audio prompt to the calling party. The audio prompt can be, for example, “please hold while your call is being connected,” followed by audible ringing. The call processing system 124 then bridges, in full duplex mode, the inbound call from the calling party to the CM subsystem 108 with the outbound VoIP call from the CM subsystem 108 to the subscriber computer 110.

Under option (3), the called party may decide to pickup the call in progress to talk to the calling party via a POTS telephone, such as the telephone terminal 112. Having screened the call, the called party can signal the call processing system 124 to indicate a desire to talk to the calling party. If the called party activates, by way of example, a “TALK @ HOME” key, the Client application 116 sends an instruction to the call processing system 124 and then substantially immediately terminates the called party's dial-up Internet session in order to make available the called party's phone line 114.

Upon receiving the instruction from the Client application 116, the call processing system 124 interrupts the recording and streaming process and plays a canned voice prompt, such as “please hold while your call is being connected,” followed by audible ringing. The call processing system 124 then proceeds to originate a new call on a free outbound voice trunk 118 from the call processing system 124 to the called party's phone line 114. The call from the call processing system 124 to the called party can be a local, intra-state, inter-state, or International PSTN call, as needed. When the called party's phone line 114 is answered a brief announcement is played to the called party and the call processing system 124 then bridges, in full duplex mode, the inbound call between the calling party and call processing system 124 with the outbound call between the call processing system 124 and called party's line 114.

Referring back to state 302, if the Caller ID is not present or the caller has been identified in a database as a telemarketer, the process proceeds to state 310, where a determination is made as to whether the telemarketing blocking function has been allowed. In particular, at state 310 a determination is made as to whether the called subscriber qualifies or is allowed to take advantage of the telemarketer blocking function. For example, subscribers may be charged an additional fee or may be required to purchase a package of services in order to qualify or be allowed to benefit from the telemarketing blocking function. Alternatively, for example, all subscribers who utilize the call processing system can be allowed to take advantage of the telemarketing blocking function, and so there may be no need to perform state 310. The process proceeds to state 312 where a determination is made as to whether the telemarketing blocking function has been enabled. Optionally, the instruction to enable or disable the telemarketing blocking function may be provided by the subscriber, the call processing system manager, or both.

If telemarketing blocking is allowed, and/or if the subscriber account number or other identifier does not fall into the trial control subscriber group, then the process proceeds to state 316. A production blocking tone is specified and an instruction that the production blocking tone is to be played before and/or after the call is answered is provided. At least one blocking tone can include, for example, the first SIT 2 tone, the first and second SIT 2 tones, or all three SIT 2 tones, as well as branding tones, which can be played before answering the call, after answering the call, or both before and after answering the call. Pre-call answering tones and post-call answering tones can be separately specified.

If the instructions provided at state 316 indicate that a specified branding tone, including the one or more blocking tones, are to be played before answering the call, then at state 318 the pre-call answering branding tone, including the selected blocking tone or tones are played, and/or the appropriate SS7 signaling call reject indicator is provided.

At state 320 the call processing system answers the call. If the instruction provided at state 316 indicates that a specified branding tone, including the one or more blocking tones, are to be played after answering the call, then at state 322 the post-call answering branding tone is provided. Optionally, at state 323, the caller is instructed to enter any or a specific DTMF tone or series of tones. If the caller does so, then the process proceeds to state 308.

If the caller proceeds to hang up within a predetermined amount of time, such as 5 or 10 seconds, after the playing of the blocking tone, or dropped the call before leaving a message then at state 326, an indication is stored in a database in association with the subscriber's account that the telemarketing call blocking was successful. At state 328, the indication is provided to the subscriber using, by way of example, the client call log presented on the subscriber's computer as discussed above. At state 330 the process ends.

Use of a subscriber computer thus provides the subscriber with enhanced call processing. The following description is by way of further illustrative examples. As previously described, when calls are received with caller ID “available and not private,” substantially immediate notification of the call can be sent to the user via the subscriber's online computer. Optionally, prior to playing a greeting to the caller, a ring-back tone is played to the caller while call information and call handling options are presented to the subscriber.

When calls come in with caller ID “unavailable or available but private,” the presentation of call information to the subscriber is delayed. First, the blocking tone is played, followed by a prompt that asks the caller to identify his or her self. For example, the prompt may state: “The household you are calling does not accept unidentified calls. Your Caller ID was not received. Please speak your name at the tone so that we can announce your call.” If the caller speaks their name, the call processing systems plays a wait message, such as: “Please wait while we announce your call.” The caller is kept on the line during call presentation to the subscriber. Thus, once the caller records his/her name, an audio or text message is sent to the subscriber's computer client that announces the call to the subscriber. For example, the announcement may state: “You have a call with caller ID from <caller's recorded name>. What do you want to do?”

The subscriber can then select from a variety of call handling options. For example, the computer client can present a visual set of call handling options, such as: “Ignore the call,” “Take the call,” and “Block Telemarketer,” or “Reject Call.” If the subscriber makes no decision within a predetermined amount of time, such as 5 seconds the call is automatically answered and, a greeting message is played to the caller and the caller's message, if any, is recorded. Alternatively, the call handling options can be presented via one of the subscriber's telephones, if not busy, using voice prompts, voice commands, and/or DTMF touch-tone entries.

If the subscriber selects “Ignore the Call,” the call processing system continues playing the ring-back to the caller for a predetermined number of ring cycles, such as 6 cycles, then disconnects the call.

If the subscriber selects “Take the Call,” the call is answered and the caller is asked to hold while the call is bridged to the subscriber via a POTS, wireless, VoIP, or other telephone connection.

If the subscriber selects Push-to-Talk the caller is asked to hold while the call is connected to the subscriber via VoIP. The subscriber will then be able to talk over a half-duplex connection using the computer terminal, wherein when the subscriber wants to talk the subscriber holds down an appropriate key, such as a keyboard key or mouse button, and the subscriber releases the key when it is the callers turn to talk.

If the subscriber selects “Reject Telemarketer,” a telemarketing rejection message is played such as: “The person you are calling does not accept phone solicitations. Please add this person's name and telephone number to your DO NOT CALL list.” The call processing system then disconnects the call. The subscriber can invoke the rejection via the client during presentation of call information, greeting, message recording, or when speaking using PTT. If the subscriber is using a phone to invoke the rejection, the subscriber can invoke the rejection by pressing a specified DTMF key, or uttering a spoken command detected using automatic speech recognition.

Optionally, if the telemarketer blocking service is an optional feature, and if a subscriber has not yet subscribed to this service, an offer to subscribe to the blocking service is provided via the client, subscriber phone or otherwise, when the call manager receives a forwarded unidentified call for the subscriber. Advantageously, the offer can be presented as an unidentified call is being processed by the call manager system.

For example, a predetermined number of ring-back cycles can be played to the caller, while the offer to subscribe and block the call is being presented to the subscriber. For example, a window or a message box can be displayed on the subscriber's computer that says: “An unidentified caller is trying to reach you. Subscribe to the telemarketer blocking service now to screen calls and block telemarketers. Click Here.”

If the subscriber clicks on the appropriate button, link, or the like to subscribe to the blocking service the call is answered with the blocking tone and the caller is prompted for the caller's name. If the caller announces his name, the subscriber is provided with the call handling options described above. If the subscriber declines the telemarketer blocking service offer, or fails to respond within a certain amount of time or rings, then the call is answered normally, that is, a greeting is played to the caller, and the caller can leave a recorded message. If the subscriber elects to subscribe to the telemarketer blocking service after the call is answered in normal fashion, the subscriber is subscribed to the service and notified that future unidentified calls will be screened for telemarketers.

The above scenarios are summarized in Table 1 below:

TABLE 1
Caller ID Scenarios

| | Caller ID | Caller ID |
|---|---|---|
| | Available | Unavailable |
| | and Not | or Available |
| | Private | But Private |
| Answer call | ✓ | ✓ |
| Play ring tone back to caller | ✓ | |
| Play telemarketer blocking tone | | ✓ |
| Prompt for name | | ✓ |
| Instruct client to notify user of incoming | ✓ | ✓ |
| call | | |
| Present call information | Show caller | Announce |
| | ID | caller |
| | | name |
| Show call handling options | ✓ | ✓ |
| Ignore call (continue play ringing to | ✓ | |
| caller) | | |
| Take the call/Push-to-Talk | ✓ | ✓ |
| Reject Telemarketer (play rejection | ✓ | ✓ |
| prompt) | | |
| Take message (default on no action) | ✓ | ✓ |
| Allow user to speak with caller (TTC/PTT) | ✓ | ✓ |
| during call (during call information, | | |
| greeting, or recording) | | |
| Allow user to play Telemarketer Rejection | ✓ | ✓ |
| message during call | | |
| (during call information, greeting, | | |
| recording message, or speaking with caller) | | |

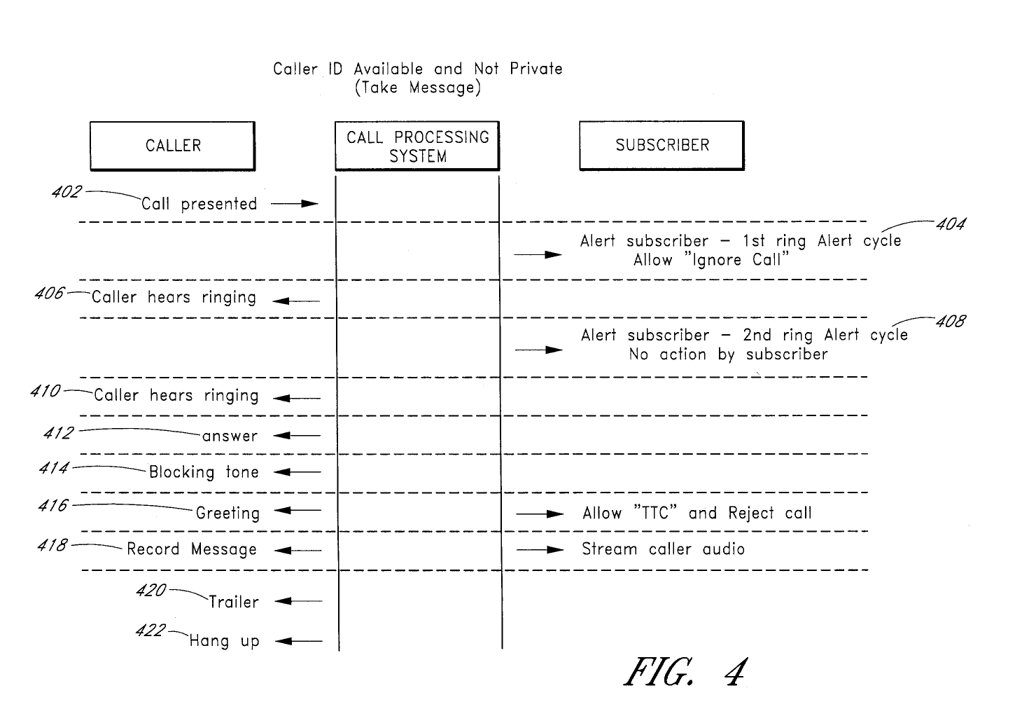

FIG. 4 illustrates a first example call handling process for the case where the caller ID is available and not private, but the subscriber does not answer the call and a message is taken. In this embodiment, the blocking tone is played even for calls having caller ID available and not private. Thus, even if a telemarketer populates the caller ID field with a real or a false Caller ID, the telemarketer will still receive a blocking signal. At state 402 a forwarded call is presented to the call manager system 124. At state 404 the subscriber is alerted that a forwarded incoming call has been received using the Client application 116. The Caller-ID of the calling party is transmitted over an opened Internet channel to the Client application 116 and is displayed to the subscriber along with an optional sound notification. The sound notification can be in the form of a first ring alert cycle produced using the subscriber's computer terminal 110 speakers.

The client application can also present to the subscriber one or more call handling options, such as: “Ignore the call,” though in this example, the subscriber declines to select an option. At state 406 the caller hears' ringing. At state 408 the subscriber is alerted with a second ring alert cycle playing on the subscriber's terminal 110 that a forwarded incoming call has been received using the Client application 116, but the subscriber takes no action. At state 410 the caller hears additional ringing. At state 412 the call manager system 124 answers the call. At state 414 a blocking tone, such as that described above, is played.

At state 416 a greeting is played. The greeting can be a “canned” greeting or a personalized greeting previously recorded by the subscriber and stored in the MS subsystem 138. In addition, the subscriber, via the Client application 116, is presented with one or more call handling options, such as, take the call or reject the call. If the subscriber elects neither of these options, the CM subsystem 108 records and stores the caller's message in the MS subsystem 138, while substantially simultaneously “streaming” the message speech through the opened Internet channel to the Client application 116 on the subscriber's computer terminal 110. The Client application 116 uses the computer terminal's codec to play the streamed speech through the speakers on the subscriber's computer terminal 110, thereby allowing the subscriber to listen to and screen the call. Optionally, to prevent the calling party from hearing any sounds made by the subscriber during the screening process, the audio return path over the Internet channel to the CM subsystem 108 is muted. A trailer message is optionally played at state 420, and the call is dropped by the call processing system 124 at state 422.

Optionally, even if the subscriber did not listen to the caller's message in real-time, the subscriber can later play back the subscriber's message via the Client application 116, or by calling in to the CM subsystem 108 to retrieve the message. Based on the message content or otherwise, the subscriber can then designate the caller as a telemarketer if the subscriber so desires.

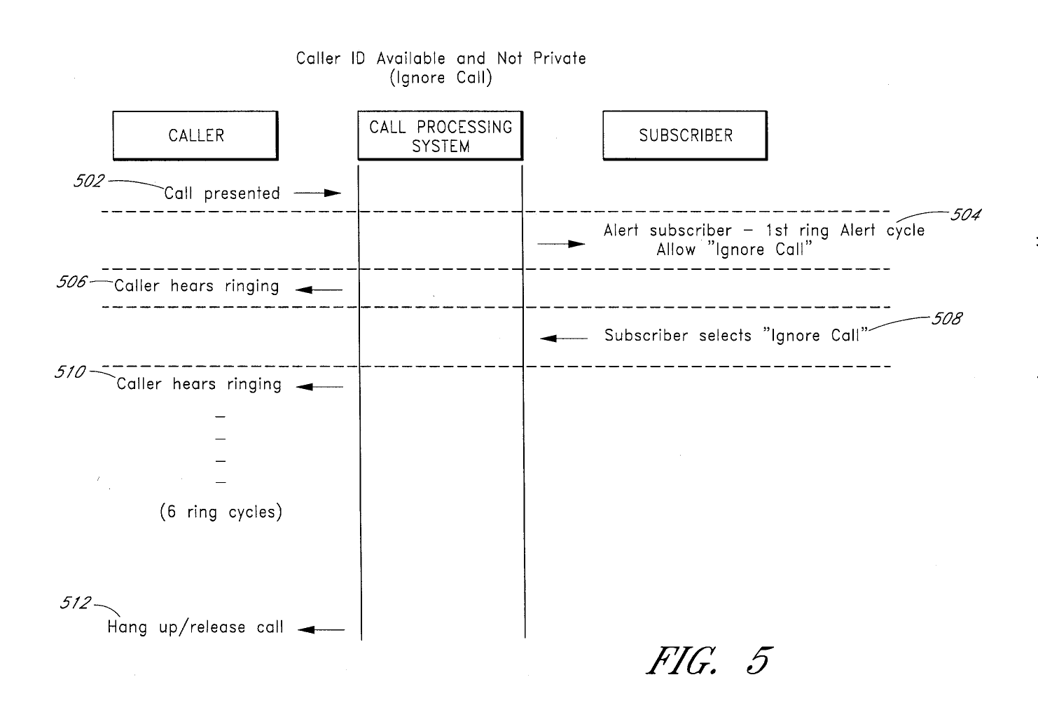

FIG. 5 illustrates an example call handling process for the case where the caller ID is available and not private, and the subscriber elects to have the call ignored. At state 502 a forwarded call is presented to the call manager system 124. At state 504 the subscriber is alerted with a first ring alert cycle playing on the subscriber's terminal 110 that a forwarded incoming call has been received using the Client application 116. The Caller-ID of the calling party is transmitted over an opened Internet channel to the Client application 116 and is displayed to the subscriber.

The Client application 116 also presents to the subscriber one or more call handling options, such as: “Ignore the call.” At state 506 the caller hears ringing. At state 508, the subscriber selects the ignore call option. At state 510 the caller hears one or more ringing cycles, for example, six ringing cycles. At state 512 the call is dropped by the call processing system 124.

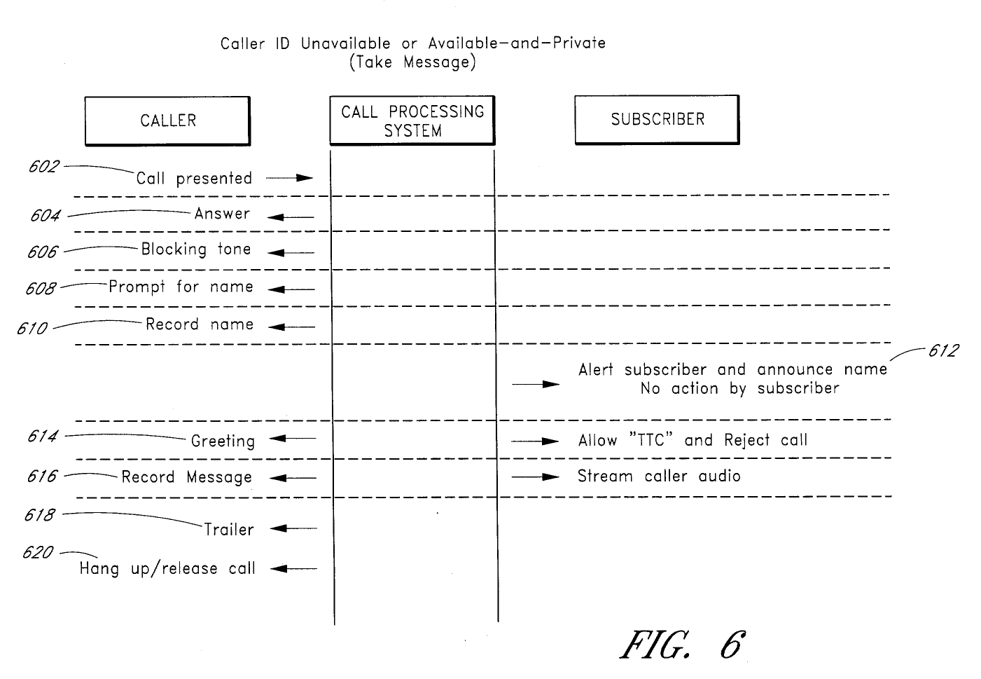

FIG. 6 illustrates an example call handling process for the case where the caller is identified as a potential telemarketer because the caller ID is unavailable or the caller ID is available, but designated as private, and a message is taken. In this example, only a post-call answer blocking tone is played, though a pre-call answer blocking tone can be played instead or in addition. At state 602 a forwarded call or direct call is presented to the call manager system 124 and is identified as being potentially from a telemarketer. Rather than immediately alerting the subscriber regarding the call, at state 604 the call is answered and at state 606 a blocking tone is played. Assuming the caller does not drop the call at this point, at state 608 the caller is prompted for the caller's name. At state 610 the caller's name is recorded. At state 612 the subscriber is alerted that a forwarded incoming call has been received via the Client application 116. The call is identified as being potentially from a telemarketer and the recorded caller's name is transmitted to the Client application 116 and announced to the subscriber.

At state 614 a greeting is played, as similarly discussed with respect to FIG. 4. In addition, the subscriber, via the Client application 116, is presented with one or more call handling options, such as, take the call or reject the call. If the subscriber elects neither of these options, the CM subsystem 108 records and stores the caller's message in the MS subsystem 138, while substantially simultaneously “streaming” the message speech through the opened Internet channel to the Client application 116 on the subscriber's computer terminal 110 so that the subscriber can hear the message in substantially real time. The subscriber can also later retrieve the stored message. Optionally, to prevent the calling party from hearing any sounds made by the subscriber during the screening process, the audio return path over the Internet channel to the CM subsystem 108 is muted. A trailer message is optionally played at state 618, and the call is dropped by the call processing system 124 at state 620.

Optionally, even if the subscriber did not listen to the caller's message in real-time, the subscriber can later play back the caller's message via the Client application 116, or by calling in to the CM subsystem 108 to retrieve the message. Based on the message content or otherwise, the subscriber can then designate the caller as a telemarketer if the subscriber so desires.

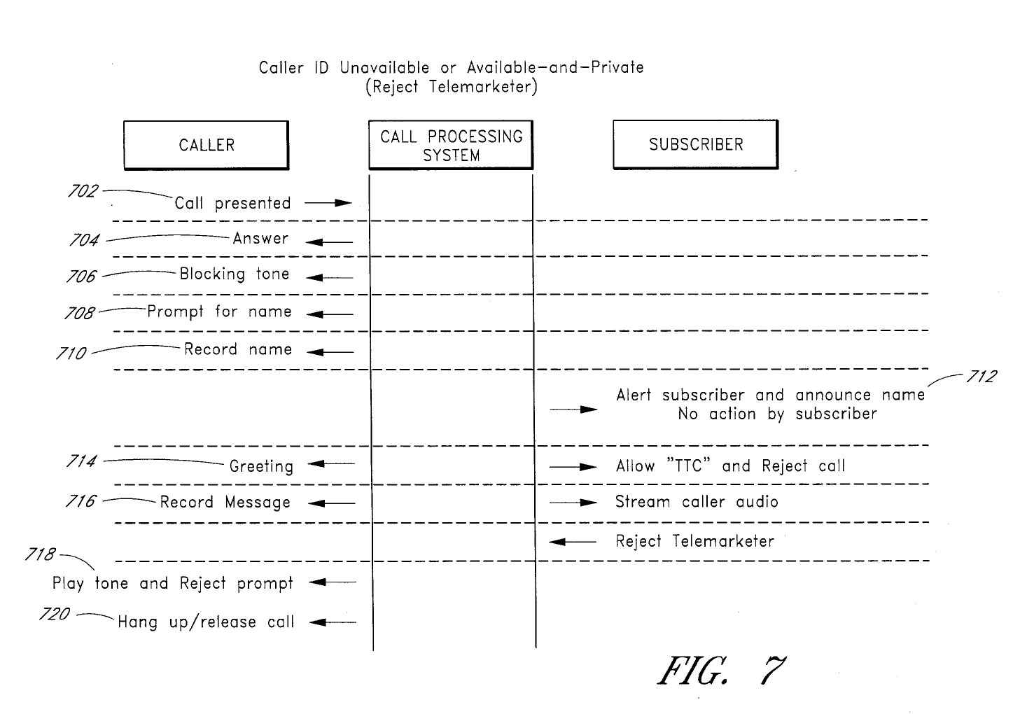

FIG. 7 illustrates an example call handling process for the case where the caller is identified as a potential telemarketer because the caller ID is unavailable or the caller ID is available, but designated as private, and the call is rejected by the subscriber. In this example, only a post-call answer blocking tone is played, though a pre-call answer blocking tone can be played instead or in addition. At state 702 a forwarded call is presented to the call manager system 124 and is identified as being potentially from a telemarketer. Rather than immediately alerting the subscriber regarding the call, at state 704 the call is answered and at state 706 a blocking tone is played. Assuming the caller does not drop the call at this point, at state 708 the caller is prompted for the caller's name. At state 710 the caller's name is recorded. At state 712 the subscriber is alerted that a forwarded incoming call has been received via the Client application 116. The call is identified as being potentially from a telemarketer and the recorded caller's name is transmitted to the Client application 116 and announced to the subscriber.

At state 714 a greeting is played, as similarly discussed with respect to FIG. 4. In addition, the subscriber, via the Client application 116, is presented with one or more call handling options, such as, take the call or reject the call. If the subscriber elects to reject the call, then at state 718 a rejection prompt, such as “please add this person's name and telephone number to your do-not-call list,” is played. The call is dropped by the call processing system 124 at state 720.

Thus, as described above, embodiments of the present invention can reduce the number of unwelcome calls, such as telemarketer calls, that are placed to subscribers, reduce the number of telemarketer calls that get through, and for telemarketer calls that do get through, notify telemarketers to subscriber names to do-not-call lists. Advantageously, telemarketer calls can be blocked even when those calls are made while the subscriber's line is busy.

It should be understood that certain variations and modifications of this invention would suggest themselves to one of ordinary skill in the art. The scope of the present invention is not to be limited by the illustrations or the foregoing descriptions thereof.

What is claimed is:

1. A method of processing calls from telemarketers, the method comprising:
receiving, at a call manager system a forwarded call from a caller intended for a called party, the forwarded call including signaling information related to the caller;
inferring that the caller is potentially a telemarketer based at least in part on determining that the signaling information does not include the caller's phone number; and
generating at least one of a Special Information Tone (SIT) and an SS7 call reject indicator at least partly in response to inferring that the caller is potentially a telemarketer.

2. The method as defined in claim 1, wherein the forwarded call is forwarded because the called party's line is busy.

3. The method as defined in claim 1, wherein the forwarded call is forwarded at least in part because called party's line is configured to forward calls on a ring-no-answer condition.

4. The method as defined in claim 1, wherein the SS7 call reject indicator is an SS7 class 10 cause code.

5. The method as defined in claim 1, wherein the SS7 call reject indicator is at least one of an SS7 class 10 cause code, an SS7 000 cause code, and an SS7 001 cause code.

6. The method as defined in claim 1, wherein the SS7 call reject indicator is a user busy indicator.

7. The method as defined in claim 1, wherein the SIT is an intercept SIT.

8. The method as defined in claim 1, further comprising:
determining if the caller dropped the call within a predetermined amount of time after causing the caller to be provided with at least a portion of a Special Information Tone (SIT);
designating the dropped call as a blocked call if the caller dropped the call within the predetermined amount of time; and
notifying a called party of the blocked call.

9. The method as defined in claim 1, further comprising requesting the caller to cease calling the called party.

10. The method as defined in claim 1, further comprising:
prompting the caller to provide identifying information;
opening a communication channel over the Internet with a networked computer associated with the called party; and
transmitting the identifying information over the Internet to the networked computer.

11. The method as defined in claim 1, further comprising:
prompting the caller to provide the caller's name;
opening a communication channel over a network with a computer associated with the called party;
streaming the caller's name to the networked computer; and
receiving an instruction from the called party to reject the caller's call.

12. The method as defined in claim 1, further comprising:
prompting the caller to provide the caller's name;
opening a communication channel over a network with a computer associated with the called party;
streaming the caller's name to the networked computer; and
receiving an instruction from the called party to connect the caller to the called party.

13. The method as defined in claim 1, further comprising:
prompting the caller to provide the caller's name;
opening a communication channel over a network with a computer associated with the called party;
streaming the caller's name to the networked computer; and
receiving an instruction from the called party to record a message from the caller.

14. A method of processing calls, the method comprising:
receiving a forwarded call from a caller intended for a called party, the forwarded call including caller signaling information;
determining that the caller is potentially a telemarketer in response to the signaling information indicating at least one of Caller ID unavailability and Caller ID private; and
providing a blocking signal at least partly in response to determining that the caller is potentially a telemarketer.

15. The method as defined in claim 14, wherein the call is forwarded because the called party's line is busy.

16. The method as defined in claim 14, wherein the blocking signal includes a Special Information Tone.

17. The method as defined in claim 14, wherein the blocking signal includes a single tone.

18. The method as defined in claim 14, wherein the blocking signal is generated before the forwarded call is accepted from an SS7 perspective.

19. The method as defined in claim 14, wherein the blocking signal is provided after the forwarded call is answered.

20. The method as defined in claim 14, wherein the blocking signal includes an SS7 instruction.

21. The method as defined in claim 14, further comprising playing a branding tone.

22. The method as defined in claim 14, further comprising receiving over a network an instruction from the called party to block telemarketing calls.

23. The method as defined in claim 14, further comprising determining if telemarketer blocking is enabled for the called party.

24. A method of processing calls, the method comprising:
receiving a call from a caller for a called party, the call including caller signaling information;
determining that the caller is potentially a telemarketer in response to the signaling information indicating at least one of Caller ID unavailability and Caller ID private; and
providing the caller with at least one of a portion of a Special Information Tone (SIT) and an SS7 call reject indicator.

25. The method as defined in claim 24, further comprising providing the at least SIT tone portion while the called party's telephone line is busy.

26. The method as defined in claim 24, further comprising receiving over a network a call processing instruction for the call from the called party via a client application executing on a computer.

27. The method as defined in claim 24, further comprising receiving a call processing instruction for the call from the called party.

28. The method as defined in claim 24, wherein the act of providing the caller with at least one of a portion of a Special Information Tone (SIT) and an SS7 call reject indicator further comprises generating at least a first of a three-tone SIT before accepting the call.

29. The method as defined in claim 24, further comprising streaming a message from the caller to a called party computer.

30. A call processing apparatus, comprising:
a first instruction configured to determine that a caller is potentially a telemarketer at least partly in response to signaling information associated with the call indicating at least one of Caller ID unavailability and Caller ID private; and
a second instruction configured to provide the caller with at least one of a portion of a Special Information Tone (SIT) and an SS7 call reject indicator.

31. The call processing apparatus as defined in claim 30, further comprising a client application configured to execute on a computer, the client application further configured to provide a called party with a telemarketing call processing interface for instructing how the call is to be handled.

32. The call processing apparatus as defined in claim 30, wherein the portion of a Special Information Tone (SIT) includes a single tone.

33. The call processing apparatus as defined in claim 30, wherein the portion of a Special Information Tone (SIT) includes two tones.

34. The call processing apparatus as defined in claim 30, wherein the portion of a Special Information Tone (SIT) includes three tones.

35. The call processing apparatus as defined in claim 30, wherein the portion of a Special Information Tone (SIT) is provided before the call is accepted.

36. The call processing apparatus as defined in claim 30, wherein the portion of a Special Information Tone (SIT) is provided after the call is answered.

37. A method of call processing, the method comprising:
receiving a caller's call at a call processing system;
inferring that the call is from a telemarketer based on call signaling data; and
providing specialized call treatment at least partly in response to inferring that the call is from a telemarketer.

38. The method as defined in claim 37, wherein the inference that the call is from a telemarketer is based at least in part on a number of calls placed by the caller within a predetermined period of time to a first set of called parties.

39. The method as defined in claim 37, wherein the inference that the call is from a telemarketer is based at least in part on a number of calls placed by the caller within a predetermined period of time to a first number of called parties.

40. The method as defined in claim 37, wherein the inference that the call is from a telemarketer is based at least in part on prior identification by at least a first call recipient that the caller is a telemarketer.

41. The method as defined in claim 37, wherein the inference that the call is from a telemarketer is based at least in part on prior identification by at least a first quantity of call recipients that the caller is a telemarketer.

42. The method as defined in claim 37, wherein the inference that the call is from a telemarketer is based at least in part on at least one of Caller ID unavailability and Caller ID private.

43. The method as defined in claim 37, wherein the specialized call treatment includes providing at least a portion of a Special Information Tone (SIT) after the call is answered.

44. The method as defined in claim 37, wherein the specialized call treatment includes providing at least a portion of a Special Information Tone (SIT) before the call is accepted.

45. The method as defined in claim 37, wherein the specialized call treatment includes providing an SS7 call rejection signal.

46. The method as defined in claim 37, wherein the specialized call treatment includes recording the caller's name and transmitting the name to a called party's computer terminal.

47. The method as defined in claim 37, wherein the specialized call treatment includes informing the caller that calls from telemarketers are not welcome.

48. The method as defined in claim 37, further comprising:
causing the caller to be provided with at least a portion of a Special Information Tone (SIT);
determining if the caller dropped the call within one of a predetermined amount of time and a predetermined amount of rings after causing the caller to be provided with at least a portion of a Special Information Tone (SIT);
designating the dropped call as a blocked call if the caller dropped the call within the predetermined amount of time; and
notifying a called party of the blocked call.

49. The method as defined in claim 37, further comprising:
instructing the caller to activate a first telephone input; and
based at least in part on the activation of the first telephone input by the caller, ceasing the specialized call treatment.

50. The method as defined in claim 37, further comprising:
instructing the caller to activate a first telephone input; and
based at least in part on the activation of the first telephone input by the caller, recording a message from the caller.

51. The method as defined in claim 37, further comprising:
instructing the caller to activate a first telephone input;
based at least in part on the activation of the first telephone input by the caller, storing in computer readable memory voice information from the caller; and
transmitting the voice information to a user so that the user can screen the call.

52. The method as defined in claim 37, further comprising receiving an indication from a called party that calls from the caller should be treated that same as a non-telemarketer call.

53. A method of call processing, the method comprising:
receiving a caller's call at a call processing system;
comparing signaling information associated with the call with information in a telemarketer database;
based on the comparison, determining that the caller is a telemarketer; and
providing specialized call treatment at least partly in response to determining that the call is from a telemarketer.

54. The method as defined in claim 53, wherein the call was forwarded from a first called party's line.

55. The method as defined in claim 53, wherein the telemarketer database is authorized by a governmental entity.

56. The method as defined in claim 53, wherein the telemarketer database is generated at least in part by a subscriber of the call processing system.

57. The method as defined in claim 53, wherein the telemarketer database is generated at least in part by a user listening to a recorded caller message and providing an indication that the caller is a telemarketer.

58. The method as defined in claim 53, wherein the telemarketer database is associated with a particular subscriber of the call processing system.

59. The method as defined in claim 53, wherein the specialized call treatment includes providing at least a portion of a Special Information Tone (SIT) after the call is answered.

60. The method as defined in claim 53, wherein the specialized call treatment includes providing at least a portion of a Special Information Tone (SIT) before the call is accepted.

61. The method as defined in claim 53, wherein the specialized call treatment includes providing an SS7 call rejection signal.

62. The method as defined in claim 53, wherein the specialized call treatment includes recording the caller's name and transmitting the name to a subscriber' computer terminal.

63. The method as defined in claim 53, wherein the specialized call treatment includes informing the caller that calls from telemarketers are not welcome.

64. The method as defined in claim 53, further comprising:
generating at least a portion of a Special Information Tone (SIT);
determining if the caller dropped the call within a predetermined amount of time;
designating the dropped call as a blocked call; and
notifying a called party of the blocked call.

65. The method as defined in claim 53, further comprising:
instructing the caller to activate a first telephone input; and
based at least in part on the activation of the first telephone input by the caller, ceasing the specialized call treatment.

66. The method as defined in claim 53, further comprising requesting the caller to press at least a first telephone key to thereby generate at least a first DTMF signal.

67. The method as defined in claim 53, further comprising:
instructing the caller to activate at least a first telephone input;
based at least in part on the activation of the first telephone input by the caller, storing in computer readable memory voice information from the caller; and
transmitting the voice information to a user so that the user can screen the call.

68. The method as defined in claim 69, further comprising receiving a DTMF signal at least partly in response to the caller activation of the first telephone input.

69. A method of processing calls, the method comprising:
receiving, at a call manager system a forwarded call from a caller intended for a called party, the forwarded call including signaling information related to the caller;
determining that the called party is a subscriber of the call manager system service; and
at least partly in response to determining that the called party is a subscriber of the call manager system service, causing the caller to be provided with at least one of a Special Information Tone (SIT) portion and an SS7 call reject indicator.

70. The method as defined in claim 69, wherein the forwarded call is forwarded because the called party's line is set to one of forward calls on busy (BCF), ring-no-answer (RNA), forward all calls, or do-not-disturb.

71. The method as defined in claim 69, wherein the forwarded call is forwarded at least in part because called party's line is configured to forward calls on ring-no-answer condition.

72. The method as defined in claim 69, wherein the SS7 call reject indicator is an SS7 class 10 cause code.

73. The method as defined in claim 69, wherein the SIT is an intercept SIT.

74. The method as defined in claim 69, wherein the Special Information Tone (SIT) portion includes one tone.

75. The method as defined in claim 69, wherein the Special Information Tone (SIT) portion includes three tones.

76. The method as defined in claim 69, further comprising:
determining if the caller dropped the call within a predetermined amount of time after causing the caller to be provided with the Special Information Tone (SIT) portion;
designating the dropped call as a blocked call; and
notifying the called party of the blocked call.

77. The method as defined in claim 69, further comprising requesting the caller to cease calling the called party.

78. The method as defined in claim 69, further comprising:
prompting the caller to provide identifying information;
opening a communication channel over the Internet with a networked computer associated with the called party; and
transmitting the identifying information over the Internet to the networked computer.

79. The method as defined in claim 69, further comprising:
prompting the caller to provide the caller's name;
opening a communication channel over a network with a computer associated with the called party;
streaming the caller's name to the networked computer; and
receiving an instruction from the called party to reject the caller's call.

80. The method as defined in claim 69, further comprising:
prompting the caller to provide the caller's name;
opening a communication channel over a network with a computer associated with the called party;
streaming the caller's name to the networked computer; and
receiving an instruction from the called party to connect the caller to the called party.

81. The method as defined in claim 69, further comprising:
prompting the caller to provide the caller's name;
opening a communication channel over a network with a computer associated with the called party;
streaming the caller's name to the networked computer; and
receiving an instruction from the called party to record a message from the caller.

82. A method of designating a call, comprising:
causing a caller to be provided with at least a portion of a Special Information Tone (SIT);
determining if the caller dropped the call within one of a predetermined amount of time and a predetermined amount of rings after causing the caller to be provided with at least a portion of a Special Information Tone (SIT); and
designating the dropped call as a blocked call if the caller dropped the call within the one of a predetermined amount of time and a predetermined amount of rings.

83. The method as defined in claim 82, further comprising notifying a called party of the blocked call.

84. The method as defined in claim 82, further comprising counting a number of blocked calls to a called party.

85. The method as defined in claim 82, further comprising:
counting a number of blocked calls to a called party; and
providing the called party with the number.

86. A method of call processing, the method comprising:
receiving a caller's call at a call processing system;
inferring that the call is potentially from a telemarketer; and
requesting that the caller enter at least a first code; and
at least partly in response to receiving the first code, allowing the caller to contact a called party.

87. The method as defined in claim 86, wherein the caller is allowed to contact the called party by recording a message for the called party.

88. The method as defined in claim 86, wherein the caller is allowed to contact the called party by connecting the caller's call to the called party.

89. The method as defined in claim 86, wherein the act of inferring is based at least in part on call signaling data.

90. The method as defined in claim 86, wherein the act of inferring is based at least in part on information stored in association with the caller's phone number.

91. A method of processing calls, the method comprising:
receiving a plurality of calls intended for a called party, the calls including caller signaling information;
determining that the calls are potentially from at least a first telemarketer in response to the signaling information indicating at least one of Caller ID unavailability and Caller ID private; and
providing a blocking signal to only a portion of the calls at least partly in response to determining that the calls are potentially from the at least first telemarketer.
